(19) United States
(12) Patent Application Publication
(10) Pub. No.: US 2003/0035624 A1
(43) Pub. Date: Feb. 20, 2003

(54) Fiber-based optical component

(76) Inventors: Keiichiro Saito, Tokyo (JP); Toshihiko Ohta, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/132,684

(22) Filed: Apr. 24, 2002

(30) Foreign Application Priority Data
Apr. 27, 2001 (JP) 2001-132143

(51) Int. Cl. G02B 6/34; G02B 6/26

(52) U.S. Cl. 385/37; 385/15

(57) ABSTRACT

A bandpass filter for a predetermined wavelength range is comprised of a pair of uniform fiber gratings each having a cutoff characteristic with a sharp inclination for prohibiting transmission of light in a longer wavelength range and a shorter wavelength range adjacent to the predetermined wavelength range, and a pair of chirped fiber gratings each having a wide cutoff band characteristic for prohibiting transmission of the light in a longer wavelength range and a shorter wavelength range adjacent to the predetermined wavelength range. The uniform fiber gratings and chirped fiber gratings are formed on the same light propagation path. A dielectric multilayer filter or an arrayed-waveguide grating is integrally incorporated to realize a fiber-based optical component which has a wavelength transmission characteristic suitable for use in a WDM system.

### BACKGROUND OF THE INVENTION

1. Field of the Invention

The present Invention relates to a fiber-based optical component which has a wavelength transmission characteristic suitable for use in wavelength division multiplexing (WDM).

2. Description of the Prior Art

In a wavelength division multiplexing (WDM) system which multiplexes a plurality of optical signals having different wavelengths for transmission, wavelength-multiplexed optical signals on a plurality of channels must be demultiplexed into individual optical signals. An optical component for use in demultiplexing optical signals is typically comprised of an arrayed-waveguide grating (AWG), a dielectric multilayer filter, a fiber Bragg grating (FBG), and the like.

Such an optical component is realized by a pair of FBGs 2, 3 formed on an optical fiber 1, for example, as shown in FIG. 1. These FBGs 2, 3 have a cutoff characteristic, as shown in FIG. 2, which sharply prevents light in both side wavelength ranges B, C sandwiching a predetermined wavelength range A. On the other hand, an AWG 4 forming part of a multiplexer (MUX) or a demultiplexer (DEMUX), or a bandpass filter (BPF) 5 has a relatively broad wave transmission characteristic D which generally includes the predetermined wavelength range A. Therefore, by combining the wavelength transmission characteristic (cutoff characteristic) formed by the FBGs 2, 3 with the wavelength transmission characteristic D exhibited by the AWG 4 and the other BPF 5, a wavelength transmission characteristic E is realized for sharply passing light in the predetermined wavelength range (wavelength width) A as a whole.

### SUMMARY OF THE INVENTION

It is an object of the present invention to provide a fiber-based optical component in a simple structure which is suitable for use in a WDM system and realizes a sharp wavelength transmission characteristic by only using a fiber grating.

The present invention takes advantage of a sharply inclined cutoff characteristic exhibited by a uniform fiber grating having a uniform grating pitch, and a broad cutoff band characteristic exhibited by a chirped fiber grating which has a grating pitch changed at a predetermined chirp rate.

The fiber-based optical component according to the present invention comprises a pair or a plurality of pairs of uniform fiber gratings having a cutoff characteristic with a sharp inclination for prohibiting transmission of light in wavelength ranges positioned on both sides of a predetermined wavelength range, and a pair or a plurality of pairs of chirped fiber gratings having a wide cutoff band characteristic for prohibiting transmittance of light in the wavelength ranges positioned on both sides of the predetermined wavelength range,

characterized in that these uniform fiber gratings and chirped fiber gratings are arranged side by side on the same light propagation path to form into a single optical fiber, by way of example, to create an optical component having a transmission characteristic which transmits light in the predetermined wavelength range.

The fiber-based optical component according to the present invention is also characterized by comprising a dielectric multilayer filter and/or an arrayed-waveguide grating for transmitting light in the predetermined wavelength range, In addition to the foregoing uniform fiber gratings and chirped fiber gratings.

### BRIEF DESCRIPTION OF THE DRAWINGS

FIG. 1 is a diagram showing the configuration of a conventional optical component using a fiber grating;

FIG. 2 shows wavelength transmission characteristics of the optical component shown in FIG. 1;

FIG. 3 shows a wavelength transmission characteristic required for a DEMUX in a WDM system;

FIG. 4 shows a band cutoff characteristic of a fiber grating itself;

FIG. 5 is a diagram generally showing the configuration of a fiber-based optical component according to one embodiment of the present invention;

FIG. 6 is a graph showing a wavelength transmission characteristic of the fiber-based optical component shown in FIG. 5; and

FIG. 7 is a graph showing a wavelength transmission characteristic of a fiber-based optical component according to the present invention when a dielectric multilayer filter is used in combination.

### DETAILED DESCRIPTION OF THE INVENTION

In the following, a fiber-based optical component having a predetermined wavelength transmission characteristic, according to one embodiment of the present invention, will be described with reference to the accompanying diagrams.

FIG. 5 generally shows the configuration of a fiber-based optical component according to this embodiment. An germanium-doped optical fiber 10 is formed with a pair of uniform fiber gratings (U-FBG) 11, 12, and with a pair of chirped fiber grating (C-FBG) 13, 14. Each of these fiber gratings (FBG) 11, 12, 13, 14 is formed, for example, by irradiating the optical fiber 10 with ultraviolet rays to change the refractive index of the core at a predetermined pitch in stripe.

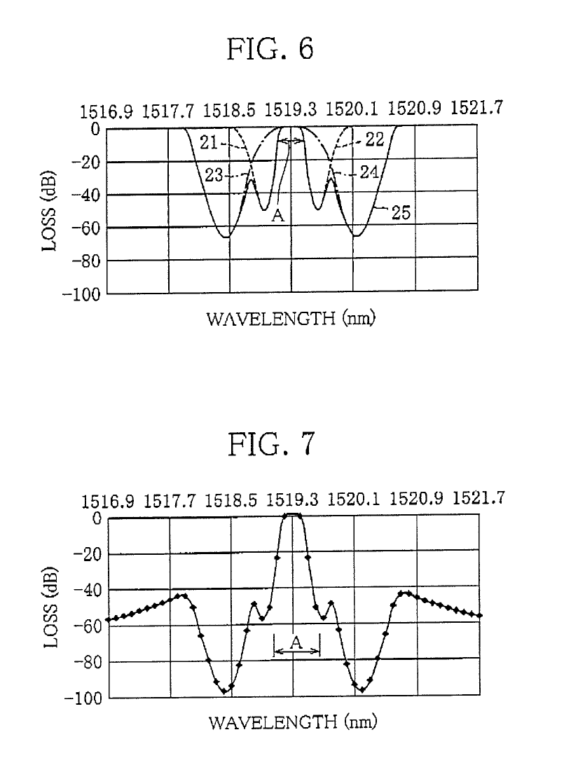

The pair of uniform fiber gratings (U-FBG) 11, 12 are formed of a plurality of gratings at a fixed pitch, and have a wavelength cutoff characteristic which cuts off light at an sharp inclination in both side wavelength ranges B, C sandwiching a predetermined wavelength range A, as shown in FIG. 2. For example, assuming that the predetermined wavelength range A extends over a width of 0.2 nm centered at a center wavelength of 1519.3 nm, as shown in FIG. 6, the U-FBG 11 is realized by forming gratings in stripe over 34 mm respectively in the longitudinal direction of the optical fiber 10 at a predetermined pitch of 520.17 nm. The U-FBG 12 in turn is realized by forming gratings in stripe over 34 mm in the longitudinal direction of the optical fiber 10 at a fixed pitch of 520.41 nm. A difference Δn in refractive index of these gratings to the core is set, for example, to 8×10⁻⁴.

On the other hand, the pair of chirped fiber gratings (C-FBG) 13, 14 are formed by changing the pitch of gratings at a predetermined chirp rate, and have a wavelength cutoff characteristic which cuts off light over a wide band in both side wavelength ranges B, C, sandwiching the predetermined wavelength range A. The C-FBG 13 having the foregoing cutoff characteristic is formed, for example, by gradually changing the pitch of gratings at a changing rate (pitch rate) of 0.65 nm/cm in the longitudinal direction of the optical fiber 10, with a reference (center) pitch defined at 520.03 nm. The C-FBG 14 in turn is formed, for example, by gradually changing the pitch of gratings at a changing rate (pitch rate) of 0.65 nm/cm in the longitudinal direction of the optical fiber 10, with a reference (center) pitch defined at 520.58 nm. These C-FBGs 13, 14 each have the grating formed over 17 mm in the longitudinal direction of the optical fiber 10, and have the difference Δn in refractive index of the gratings to the core set, for example, at 2×10⁻³.

According to the fiber-based optical component composed of the aforementioned pair of U-FBGs 11, 12 and pair of C-FBGs 13, 14 formed on the optical fiber 10, each of the U-FBGs 11, 12 exhibits a wavelength cutoff characteristic which has a narrow cutoff band but a sharp inclination on both sides of the wavelength range A, as indicated by broken lines 21, 22 in FIG. 6. On the other hand, each of the FBGs 13, 14 has a wavelength cutoff characteristic which has a broad inclination but a wide cutoff band, as indicated by one-dot-chain lines 23, 24 in FIG. 6. As a result, the fiber-based optical component exhibits a wavelength cutoff characteristic (wavelength transmission characteristic) which cuts off light at a sharp inclination on both sides of the predetermined wavelength range A and has a sufficiently wide cutoff range.

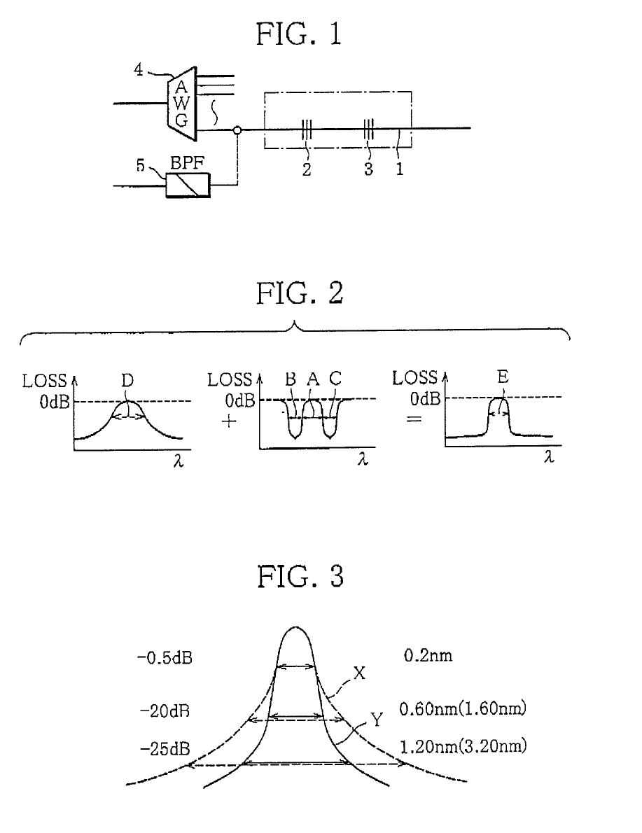

Also, as shown in FIG. 1, when such a fiber-based optical component is connected to an arrayed-waveguide grating (AWG) and a BPF to use in combination a wavelength transmission characteristic, exhibited by the AWG 4 and dielectric multilayer filter, which has a cutoff characteristic that is broad but extends over a wide band, it is possible to realize an optical component which has a cutoff characteristic, for example, as shown in FIG. 7, which cuts off light at a sharp inclination at both sides of the predetermined wavelength range A and has a wider cutoff range. In other words, it is possible to effectively realize an optical component which sharply transmits only light in the predetermined wavelength range A.

For example, for ensuring a channel separation accuracy in a DEMUX in a WDM system whose wavelength multiplexes optical signals on a plurality of channels at intervals of 100 GHz (0.8 nm), each channel must have a wavelength transmission characteristic as indicated by a broken line X in FIG. 3. Specifically, an optical component for each channel must have a transmission characteristic which ensures 0.20 nm or more for a transmission wavelength width at −0.5 dB. Further, the optical component must have a cutoff characteristic which cuts off wavelength components other than those within a wavelength width of 1.60 nm at −20 dB to ensure crosstalk between adjacent channels. Further, the optical component must have a cutoff characteristic which cuts off wavelength components other than those within a wavelength width of 3.20 nm at −25 dB to ensure crosstalk between non-adjacent channels.

As wavelength multiplexing is further developed to wavelength multiplex optical signals, for example, at intervals of 37.5 GHz (0.3 nm), an optical component for each channel is required to have a sharp wavelength transmission characteristic, for example, as indicated by a solid line Y in FIG. 3. Specifically, each optical component must ensure 0.20 nm or more for a transmission wavelength width at −0.5 dB, and have a characteristic which cuts off wavelength components other than those within a width of 0.60 nm at −20 dB to ensure crosstalk between adjacent channels. In addition, each optical component must have a characteristic which cuts off wavelength components other than those within a width of 1.20 nm at −25 dB to ensure crosstalk between non-adjacent channels.

However, it is difficult to realize such a cutoff characteristic which exhibits a sharp inclination from −0.5 dB to −20 dB as described above by using only the aforementioned FBGs 2, 3 having the cutoff characteristics B, C, AWG 4 having the broad wavelength transmission characteristic D, and the like.

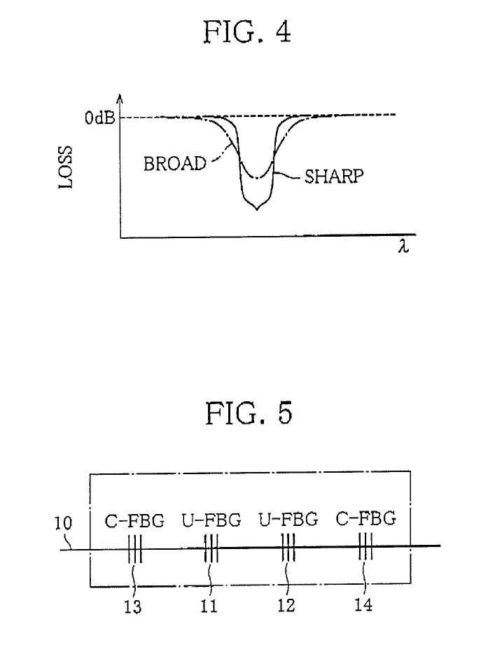

For reference, for realizing the foregoing cutoff characteristic with a sharp inclination from −0.5 dB to −20 dB, the cutoff characteristics B, C of the FBGs 2, 3 themselves, for example, must be sharp, as shown in FIG. 4. However, if the FBGs 2, 3 are designed to have such a sharp cutoff characteristic, a new problem arises that the cutoff band itself becomes too narrow. Also, even if the aforementioned bandpass characteristic D in the AWG 4 is used in combination, it is difficult to ensure crosstalk for non-adjacent channels.

In this respect, even when optical signals wavelength multiplexed, for example, at intervals of 37.5 GHz (0.3 nm) are demultiplexed for each channel, the present invention can ensure 0.20 nm or more for the transmission wavelength width at −0.5 dB (transmission characteristic) and cutoff wavelength components other than those within a width of 0.60 nm at −20 dB without fail to ensure crosstalk between adjacent channels. Further, it is possible to realize an optical component having a wavelength transmission characteristic which cuts off wavelength components other than those within a width of 1.20 nm at −25 dB without fail to sufficiently ensure crosstalk between nonadjacent channels.

It should be understood that even for realizing a higher density wavelength multiplexing system at intervals of 37.5 GHz (0.3 nm) or higher, an optical component having a desired band transmission characteristic can be implemented in a similar approach.

Moreover, since the foregoing configuration only requires the formation of the pair of U-FBGs 11, 12 and the pair of C-FGBs 13, 14 on the optical fiber 10, the resulting optical component is simple. The optical component can be used as having a desired wavelength transmission characteristic, I.e., as a fiber-based optical component which functions independently, so that its practical advantage is significant.

The present invention is not limited to the aforementioned embodiment. For example, it should be understood that the cutoff characteristic of each of the pair of U-FBGs 11, 12 and the pair of C-FBGs 13, 14 may be defined in accordance with the center wavelength of the wavelength range A to be extracted, and its wavelength width. Also, while the aforementioned embodiment realizes the fiber-based optical component using the pair of U-FBGs 11, 12 and the pair of C-FBGs 13, 14, needless to say, it is possible to realize an optical fiber component using, for example, a pair of U-FBGs 11, 12 and a plurality of pairs of C-FBGs. Further, a plurality of pairs of the U-FBGs and C-FBGs may be provided. The present invention is not limited in particular, either, to the order in which these U-FBGs and C-FBGs are formed.

It is possible, as a matter of course, to integrally incorporate the aforementioned dielectric multilayer filter and an arrayed-waveguide grating into the fiber-based optical component. Otherwise, the present invention can be practiced in a variety of modifications without departing from the spirit and scope of the invention.

As described above, according to the present invention. a fiber-based optical component which transmits light only in the predetermined wavelength range can be realized in a simple configuration using uniform fiber gratings and chirped fiber gratings, thus providing significant practical advantages as a fiber-based optical component for use in a wavelength multiplexing optical communication (WDM) system.

What is claimed is:

1. A fiber-based optical component comprising:
a pair or a plurality of pairs of uniform fiber gratings provided on the same light propagation path, said uniform fiber gratings each having a transmission characteristic which prohibits transmission of light in a longer wavelength range and a shorter wavelength range adjacent to a predetermined wavelength range, respectively: and
a pair or a plurality of pairs of chirped fiber gratings provided on the light propagation path on which said uniform fiber gratings are provided, said chirped fiber gratings each having a transmission characteristic which prohibits transmission of light in a longer wavelength range and a shorter wavelength range adjacent to said predetermined wavelength range, respectively.

2. The fiber-based optical component according to claim 1, wherein:
said chirped fiber gratings and said uniform fiber gratings are formed at different positions from one another on a single optical fiber which serves as a light propagation path.

3. The fiber-based optical component according to claim 1, further comprising:
a dielectric multilayer filter which transmits light in said predetermined wavelength range.

4. The fiber-based optical component according to claim 3, wherein:
said dielectric multilayer filter is provided at an end of the optical fiber which is formed with said chirped fiber gratings and said uniform fiber gratings.

5. The fiber-based optical component according to claim 1, further comprising:
an arrayed-waveguide grating for transmitting light in said predetermined wavelength range.

6. The fiber-based optical component according to claim 5, wherein:
said arrayed-waveguide grating is provided at an end of the optical fiber which is formed with said chirped fiber gratings and said uniform fiber gratings.
